(19) United States
(12) Patent Application Publication
(10) Pub. No.: US 2025/0219111 A1
(43) Pub. Date: Jul. 3, 2025

(54) REDOX FLOW BATTERY STACK HAVING CURVED DESIGN FOR MINIMIZING PRESSURE DROP

(71) Applicant: Dubai Electricity and Water Authority PJSC, Dubai (AE)

(72) Inventors: Abdulmonem FETYAN, Dubai (AE); Anugrah ANDISETIAWAN, Dubai (AE); Rahmat Agung SUSANTYOKO, Dubai (AE); Musbaudeen Oladiran BAMGBOPA, Dubai (AE); Ayoob Mohamed Sabt Ali ALHAMMADI, Dubai (AE); Tawaddod Saif Mohamed Helal ALKINDI, Dubai (AE)

(21) Appl. No.: 18/855,481

(22) PCT Filed: Apr. 4, 2023
(86) PCT No.: PCT/IB2023/053394

§ 371 Date: Oct. 9, 2024

(30) Foreign Application Priority Data
Apr. 13, 2022 (AE) P6000656/2022

(51) Int. Cl. H01M 8/04082; H01M 4/86; H01M 8/0258; H01M 8/0276; H01M 8/18

(52) U.S. Cl. CPC H01M 8/04201; H01M 4/86; H01M 8/0258; H01M 8/0276; H01M 8/188

(57) ABSTRACT

The present invention relates to a redox flow battery cell stack having a streamlined shape design that allows an improved electrolyte distribution, and decreases the pressure drop thereof, through increasing the size of the cell at the inlet and middle portion and decreasing the size at the outlet portion. The redox flow battery cell stack comprises at least one membrane; at least two flow frames disposed on both sides of the membrane; at least two electrodes disposed in cavities inside the flow frames; at least two gaskets between said frames, at least two bipolar plates and at least two outer frames; and two inlets and two outlets for circulating electrolytes; characterized in that said electrodes have a streamlined design; wherein the length thereof is larger than the width thereof, and the inlet and middle portions having dimensions larger than the outlet thereof.

### FIELD OF INVENTION

The present invention generally relates to a redox flow battery stack having a construction that allows an improved electrolyte distribution, and decreases the pressure drop thereof. In particular, the present invention relates to a redox flow battery cell stack having a streamlined design.

### BACKGROUND

Energy production from renewable resources has been witnessed a remarkable increase over the recent years, since the world became aware of the drawbacks of fossil fuel and the possibility of the deficiency thereof in the future. In this sense, not only energy production became of great concern, but also storage systems thereof.

Redox flow batteries (RFBs) are considered the most promising technology for energy storage, due to the ability thereof to be combined with energy conversion technologies from renewable sources, as well as the outstanding ability thereof to store large amounts of electrical energy at low cost.

The redox flow battery is a battery charged and discharged by utilizing the difference in oxidation-reduction potential between an ion contained in a positive electrode electrolyte and an ion contained in a negative electrode electrolyte.

A basic redox flow system, such as the one illustrated in FIG. 1 by reference number 10, comprises electrochemical cell where the reactions take place, storage tanks (5a, 5b) to store the electrolytes, and pumps (4a, 4b) to circulate the electrolytes, a membrane (1) which is an ion exchange membrane that separates the electrodes and prevents the electrolytes from mixing, but allows selected ions to pass through, to complete the redox reactions, two electrodes (2a, 2b) and two current collectors (3a, 3b). When necessary, electrochemical cells are repeated to construct stacked cell, such as the one illustrated in FIG. 2 by reference number 20, which is constructed as layers of bipolar plates represents a positive current collector (22a) and a negative current collector (22b), ion exchange membrane or separator (21), positive electrode (23a), negative electrode (23b). The pumps circulate the electrolyte in the stack through flow field to pass the electrode resulting in pressure drop. The pressure drop is known to be proportional to the path length of the electrolyte. Accordingly, the pumps consume more power to pump the electrolyte through larger cell's size. Bearing in mind that the higher the pressure drop is resulted; the lower efficiency of the system is obtained. Therefore, several attempts are made to decrease the pressure drop, in an effort to enhance the overall efficiency and performance of the system.

One of the suggested methods to decrease the pressure drop is reducing the pumping flow rate. However, there are some drawbacks of said method, such as increasing concentration polarization, reducing the voltage efficiency, and decreasing the limiting current density; and finally high-power density will be hardly obtained in that system. Another solution is increasing the flow rate; however, this results in higher power consumption by pumps [7]. The higher power consumption by pumps will lead to lowering the overall efficiency and performance of the system.

Conventional designs of the redox flow stacks, known from the prior art, are based on rectangular planar shape. However, in conventional rectangular stack, inactive sites usually exist at the four corners of the cell (demonstrated in blue color in FIG. 5b). Said inactive sites restrict mass transport of the reactants at the electrolyte/electrode interface.

Several approaches have been followed in order to remedy the shortcoming of the rectangular redox flow stacks. One of those approaches is introducing complex manifold, flow field channels, or pathways in the flow frame to distribute the electrolyte through the electrode. For example, U.S. Pat. No. 10,381,667B2 discloses rectangular stack with manifold comprising fluid distribution channels in a serpentine arrangement, wherein the bipolar plate of the stack comprises a plurality of interdigitated flow channels on at least one surface. The support frame comprises an inlet manifold formed into a facing surface of the first side of the frame, the inlet manifold comprising fluid inlet distribution channels in a serpentine arrangement, each fluid inlet distribution channel aligned with a single inlet flow channel of the bipolar plate; and an outlet manifold formed into the facing surface of the opposing side of the frame, the outlet manifold comprising fluid outlet distribution channels in a serpentine arrangement, each fluid outlet distribution channel aligned with a single outlet flow channel of the bipolar plate.

US20160164112A1 discloses a cell of a redox flow battery, having at least one cell frame element, a membrane and two electrodes. The at least one cell frame element, the membrane and the two electrodes surround two cell inner spaces which are separate from each other. In the at least one cell frame element, at least four separate channels are provided in such a manner that different electrolyte solutions can flow through the two cell inner spaces. With the exception of the at least four separate channels, the cell is constructed in a fluid-tight manner. The cell frame element is welded to the membrane, the two electrodes, and/or at least one additional cell frame element to provide the redox flow battery with a higher power of density.

WO2020129022A2 A redox flow battery comprising a redox flow stack comprising a plurality of flow frames arranged face-to-face in said stack, each frame having a support border surrounding a central opening, each frame having a first and a second face, and each frame comprising: a bipolar plate fitted in said central opening providing a fluid-tight seal and defining two chambers on each face of said bipolar plate; two porous electrodes, each respectively contained in one of said chambers; an ion-selective membrane for interfacing with the next frame in said stack; and openings for posilyte and negolyte flow respectively through one of said electrodes; wherein each said face of the support border has a first border region and a second border region arranged in opposite ends in respect of said central opening, each said border region comprising meandering channels for posilyte or negolyte flow through a respective frame chamber.

However, introducing complex manifold, flow field channels and pathways to the frame necessitates increased production costs. The increased production costs will complicate the RFB way of competition with other batteries.

On the other hand, some approaches have addressed the performance's enhancement of redox flow battery by improving the uniformity of the cross-sectional velocity and therefore increasing the power density of the battery stack. The proposed geometry is based on circular or radial design [1, 2, 3]. Circular vanadium flow battery, for example, was investigated with enhanced mass transport and reduced concentration polarization. Nevertheless, beside the cost associated with sealing of such stack design which will increase the production cost drastically, said designs have introduced an inlet geometry area bigger than the one associated to the outlet and therefore the overall pressure drop for such designs will be much higher than the rectangular designs and subsequently increase the power consumption by pumps [1, 2, 3].

In addition, tubular stack designs have been also proposed to overcome the challenges linked to rectangular shape designs [4, 5, 6], however, such designs are limited due to the low current density which can be applied, high ohmic resistance or overall higher pressure drop. For example, a paper published by S. Ressel, et al (2017) has presented a vanadium redox flow battery with a tubular cell design which shall lead to a reduction of cell manufacturing costs and the realization of cell stacks with reduced shunt current losses. Charge/discharge cycling and polarization curve measurements are performed to characterize the single test cell performance. A maximum current density of 70 mAcm⁻² and power density of 142 Wl⁻¹ (per cell volume) is achieved and Ohmic overpotential is identified as the dominant portion of the total cell overpotential. Cycling displays Coulomb efficiencies of ≈95% and energy efficiencies of ≈55%. During 113 h of operation a stable Ohmic cell resistance is observed [4]. Although said designs suggesting tubular RFB successfully demonstrated lower pumping rate, current density is limited to 70 mA cm⁻² only and system demonstrated high ohmic resistance [4]. Such low current density will limit the utilization of the battery especially for large scale application.

In this context, there is still a need for providing an improved redox flow stacks for solving the problem of electrolyte mass transport restrictions, reducing the internal power consumption and enhancing the efficiency of the system without increasing the cost of production, in particular, on the basis of large-scale production. Since that large-scale production of such stacks is still being limited, up till now, by high cost of assembly and maintenance.

### SUMMARY OF THE INVENTION

In view of the technical problem discussed above, the present invention provides a redox flow battery cell stack having a streamlined shape design that allows an improved electrolyte distribution, and decreases the pressure drop thereof, through increasing the size of the cell at the inlet and middle portion and decreasing the size at the outlet portion. According to the present invention, the streamlined shape can be identified, for example, mathematically by using the following reported Gielis equation [8]:

$$r = \frac{1}{{\{ {( \vert \frac{1}{a} cos ( φ \frac{m}{4} ) \vert )}^{n 2} + {( \vert \frac{1}{b} sin ( φ \frac{m}{4} ) \vert )}^{n 3} \}}^{\frac{1}{n 1}}}$$

where r is the polar radius (i.e., the distance between the polar origin and the point), m, a, b, n1, n2, and n3 are constants.
The x and y position are presented as:

$$x = r \cdot cos φ \\ y = r \cdot sin φ$$

where the different dimensions of the streamlined design can be determined by varying the above constants, wherein m=1-1.5, a=b=1-100, n1=n2=n3=0.8-1.5, as shown in FIGS. 12 a-d. However, as it is known by those persons skilled in the art, any other equations, that result in generating the same streamlined shapes, or cross-sections thereof, may be used. The end at the apex can be fillet or rounded to decrease the pressure drop and increase the utilization of the electrode.

The streamlined redox flow battery cell stack comprises at least one membrane; at least two flow frames disposed on both sides of the membrane; at least two electrodes disposed in cavities inside the flow frames; at least two gaskets between said frames, at least two bipolar plates and at least two outer frames.

One object of the new streamlined shape design of the invention is to eliminate the inactive sites of the electrode without the need of using complex manifold channels, by simply cutting off the unused parts of the material and supply the electrolyte directly to the electrode by introducing an inlet inside the geometry of the electrode.

Another object of the new shape design of the present invention is to facilitate less flow pumping rate by introducing smooth streamline flow in the electrode by increasing the size of the cell at the inlet and middle portion and decreasing the size at the outlet portion, resulting in higher reactant distribution and therefore higher species conversion compared to rectangular designs.

Still another object of the streamline design is to enhance the power density of redox flow batteries, through reducing the electrolyte mass transport restrictions and utilizing the whole active surface area of the electrodes and bipolar plates which results in reducing the manufacturing costs.

Further, said design can ease the use of high current densities, while better distributed current densities over the electrode surface can be utilized by increasing the reactants velocity and concentrations.

According to one embodiment of the present invention, the cells of the redox flow battery cell stack may comprise electrolyte inlets and outlets directly placed inside the electrode area. The electrolyte inlets are at the base and electrolyte outlets are at the apex.

According to another embodiment, the bipolar plate and flow frame are combined to form one component or divided into two separate components.

According to another embodiment, the outer frames of the cell may comprise rectangular shape, streamlined design shape, circular shape or any other shapes.

According to another embodiment, the flow frames/bipolar plates may comprise inlet and outlet channels manifold dividing the electrolyte into at least two sub-channels. In this case the inlets and outlets are placed outside the electrode area.

According to another embodiment, the cell may consist of one streamlined design shape cavity or a plurality of streamlined design shape cavities in radial or planar arrangement, or any other arrangements, to maximize power and area utilization and minimize unused area in the cell geometry.

According another embodiment, the bipolar plate structure may contain veins as protrusions, the protrusions are directed towards the electrode side to facilitate electrolyte distribution, increase the electrical conductivity between bipolar plate and electrode and decrease the contact resistance.

### BRIEF DESCRIPTION OF THE DRAWINGS

FIG. 1: shows a typical redox flow system according to the prior art.

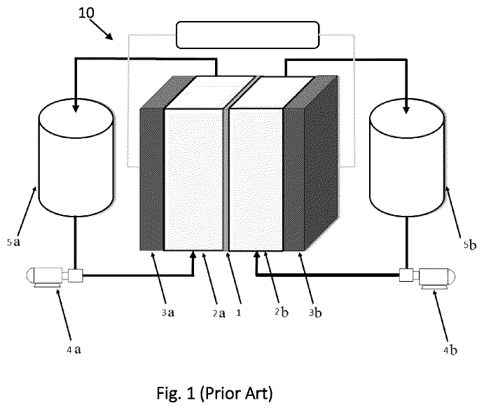

FIG. 2: shows a typical redox flow battery stacked cells comprising a repeated unit cell according to the prior art.

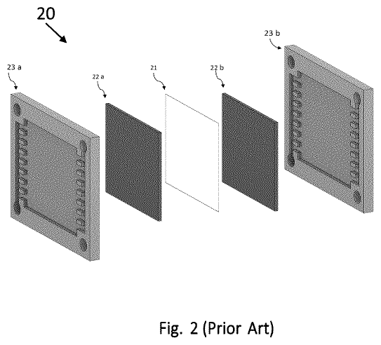

FIG. 3: shows a schematic view of a streamlined design cell (30) of the invention which comprises electrolyte inlets and outlets directly placed inside the electrode geometry.

FIG. 4: a) an exploded view of a streamlined design cell (30) of the invention which comprises electrolyte inlets and outlets directly placed inside the electrode geometry.

FIG. 5: shows simulated velocity contour plots (cm s⁻¹) for a) streamlined design (inventive design) and b) rectangular design (prior art).

FIG. 6: shows simulated V³⁺ concentration contour plots (mol m⁻³) at the electrode/collector interface for a) streamlined design (inventive design) at 1s, b) streamlined design (inventive design) at 3s c) rectangular design (prior art) at 1s and d) rectangular design (prior art) at 3s.

FIG. 7: shows simulated pressure drop plots (kPa) for a) streamlined design (inventive design) and b) rectangular design (prior art).

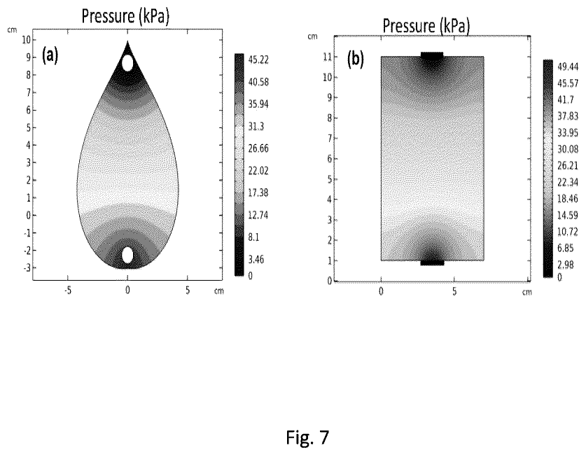

FIG. 8: shows a view of streamlined design flow frame (inventive design) with inlet and outlet outside the electrode area and connected by manifolds.

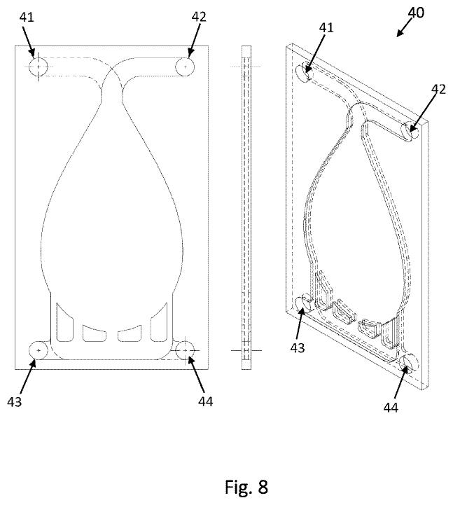

FIG. 9: shows a 3D exploded view of the stack configuration with streamlined design flow frame with manifold.

FIG. 10: shows simulated velocity contour plots (cm s⁻¹) for the streamlined design with manifold channels (inventive design).

FIG. 11: shows simulated V³⁺ concentration contour plots (mol m⁻³) at the electrode/collector interface for streamlined design with manifold (inventive design) at 1s, b) streamlined design with manifold (inventive design) at 3s

FIG. 12: shows different streamlined design shapes generated by Gielis equation by selected parameters: (a) m,a,b=1 and 0.8≤n≤1.5; (b) a,b=1,n=0.8, and 1≤m≤1.5; (c) m=1.5,b=1,n=0.8, and 1≤a≤100; (d) m=1.5,a=3,b=1,n=1.8, which is the shape parameter used for stack drawing in this proposal.

FIG. 13: shows schematic view of streamlined design cell (inventive design) with several cavities in (a) planar arrangement, (b) radial arrangement.

FIG. 14: shows a view of bipolar plate structure comprising veins as protrusions (inventive design).

FIG. 15: shows a 3D exploded view of stack configuration with streamlined design flow frame with veins protrusions (inventive design).

### DETAILED DESCRIPTION

The present invention provides a redox flow battery cell stack having a streamlined shape design that allows an improved electrolyte distribution, and decreases the pressure drop thereof, through increasing the size of the cell at the inlet and middle portion, and decreasing the size at the outlet portion.

### Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. The examples are illustrative only and not intended to be limiting. Other features of the disclosure are apparent from the following detailed description and the claims.

Definitions of common terms in chemistry may be found in Richard J. Lewis, Sr. (ed.), Hawley's Condensed Chemical Dictionary, published by John Wiley & Sons, Inc., 1997 (ISBN 0-471-29205-2).

In order to facilitate review of the various embodiments of the disclosure, the following explanations of specific terms are provided:

Bipolar Plate: refers to a conductive plate that has a positively charged surface and a negatively charged surface during use in a redox flow battery.

Electrolyte: refers to a substance containing free ions that behaves as an electrically conductive medium. Electrolytes generally comprise ions in a solution.

Manifold: As used herein, the term “manifold” refers to plurality of fluid distribution channels that are in fluid communication with an inlet port or outlet port.

Streamlined shape/design: as used herein, the term “streamlined shape” for the cell stack refers to geometrical shape, where the size of the cell at the inlet and middle portion are greater than the size at the outlet portion, and the end at the apex of the cell is rounded or filet.

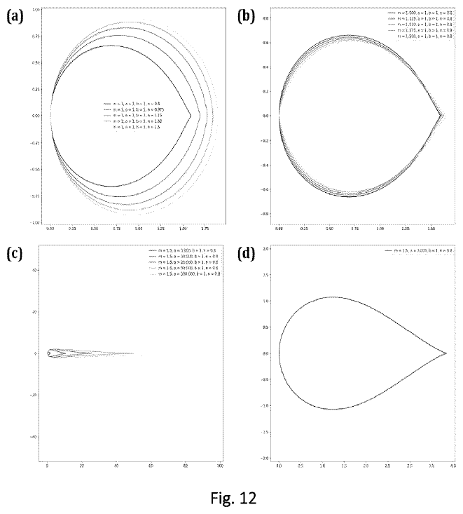

Referring to FIG. 12), the streamlined shape can be in the form of a leaf-like, diamond or oval shape, or any other streamlined shapes identified, for example, mathematically by the use of the following reported Gielis equation:

$$r = \frac{1}{{\{ {( \vert \frac{1}{a} cos ( φ \frac{m}{4} ) \vert )}^{n 2} + {( \vert \frac{1}{b} sin ( φ \frac{m}{4} ) \vert )}^{n 3} \}}^{\frac{1}{n 1}}}$$

where r is the polar radius (i.e., the distance between the polar origin and the point), m, a, b, n1, n2, and n3 are constants.
The x and y position are presented as:

$$x = r \cdot cos φ \\ y = r \cdot sin φ$$

where the different dimensions of the streamlined design can be determined by varying the above constants, wherein m=1-1.5, a=b=1-100, n1=n2=n3=0.8-1.5, as shown in FIGS. 12 a-d. However, as it is known by those persons skilled in the art, any other equations that result in generating the same streamlined shapes, or cross-sections thereof, may be used. The end at the apex can be fillet or rounded to decrease the pressure drop and increase the utilization of the electrode.

Different embodiments of a redox flow battery cell stack having a streamlined shape design will be described in more detail below.

Example I: Redox Flow Battery Stack Cell having streamlined Design, wherein electrolyte inlets and outlets are directly placed inside the electrodes geometry.

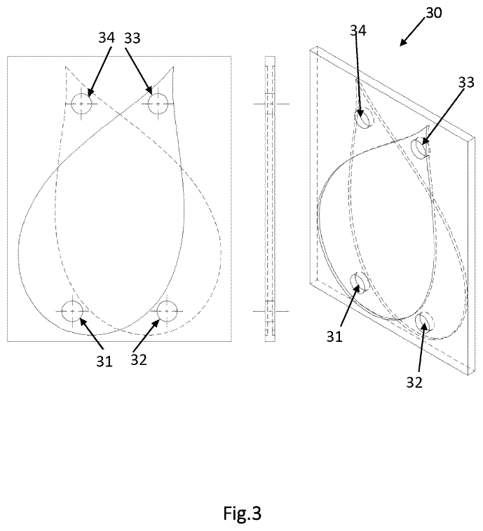

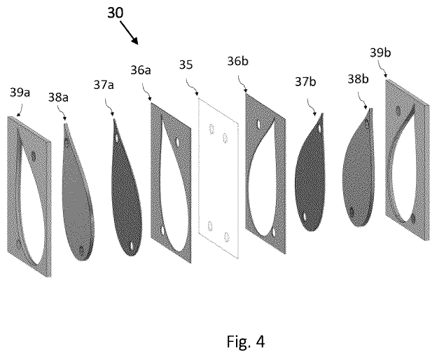

With reference to FIGS. (3) and (4), a first embodiment of a streamlined cell (30) is shown, wherein electrolyte inlets, comprising positive electrolyte inlet (31) and negative electrolyte inlet (32), and outlets, comprising positive electrolyte outlet (33), negative electrolyte outlet (34), are directly placed inside the electrodes (37a, 37b) geometry, as shown in FIG. 3. According to this embodiment, the streamlined cell (30) consists of one streamlined cavity. As shown in FIG. 4), the streamlined cell (30) comprises ion exchange membrane (35), Gasket (36 a, 36 b), Electrodes (37a, 37b), bipolar plates (38a, 38b), Flow frame (39a, 39b). The electrodes (37a, 37b) of the cell have a streamlined design, wherein the length of the cell is greater than the width of the cell and the electrolyte inlets are at the base and electrolyte outlets are at the apex. The bipolar plate and flow frame of the cell are two separate components. According to this example, the complex inlet manifold is replaced by an inlet inside the electrode geometry.

Example II: Redox Flow Battery Stack Cell having streamlined design wherein electrolyte inlets and outlets are placed outside the electrode geometry.

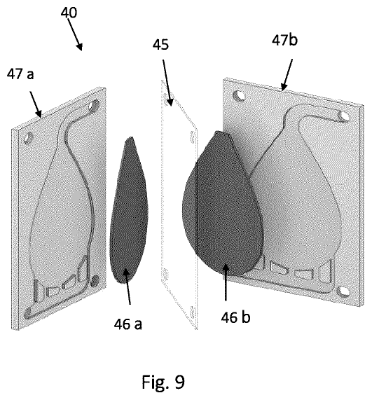

With reference to FIGS. (8) and (9), a second embodiment of a streamlined cell (40) is shown, wherein electrolyte inlets, comprising positive electrolyte inlet (43) and negative electrolyte inlet (44), and outlets, comprising positive electrolyte outlet (42), negative electrolyte outlet (41), are placed outside the electrode geometry, and wherein the electrolyte is supplied by manifold channels dividing the electrolyte into sub-channels at the flow frames/bipolar plates. The streamlined cell (40) comprises ion exchange membrane (45), electrodes (46a, 46b), wherein bipolar plates and flow frames are combined together to form one component (47a, 47b), as shown in FIG. 9. The electrodes (46a, 46b) of the cell have a streamlined design, wherein the length of the cell is greater than the width of the cell and the electrolyte inlets are at the base and electrolyte outlets are at the apex. The inlets and outlets are placed outside the electrode geometry and the electrolyte is supplied by manifold channels dividing the electrolyte into sub-channels at the flow frames/bipolar plates. This design is more beneficial in increasing the overlap between both negative and positive electrodes.

Example III: Redox Flow Battery Stack Cell having Streamlined Design, wherein the bipolar plate structure contains veins as protrusions.

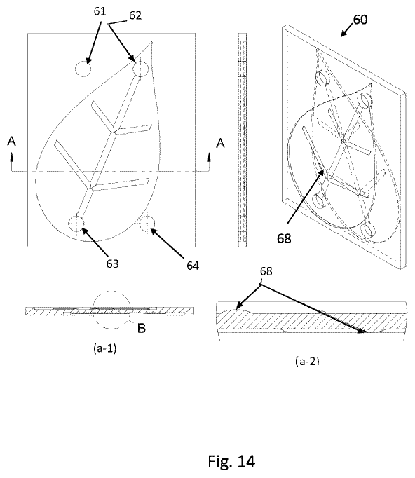

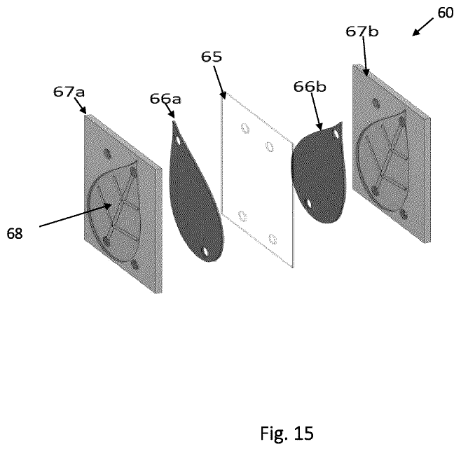

Referring to FIGS. (14) and (15), a Redox Flow Battery Stack Cell (60) having Streamlined Design is shown, wherein the bipolar plate and flow frames are combined together to form one component (67a, 67b). The electrodes (66a, 66b) of the cell have a streamlined design, wherein the length of the cell is greater than the width of the cell and the electrolyte inlets are at the base and electrolyte outlets are at the apex, and wherein the bipolar structure (67a, 67b) contains veins as protrusions (68). The protrusions (68) are directed towards the electrode side to facilitate electrolyte distribution, increase the electrical conductivity between bipolar plate and electrode and decrease the contact resistance. In this example, Electrolyte inlets, positive electrolyte inlet (61) and negative electrolyte inlet (62), and electrolyte outlets, positive electrolyte outlet (63), negative electrolyte outlet (64), are directly placed inside the electrodes (66a, 66b) geometry, as shown in FIGS. 14 and 15.

Example IV: Redox Flow Battery Stack cell (50) according to one aspect of the invention comprising a plurality of streamlined cavities.

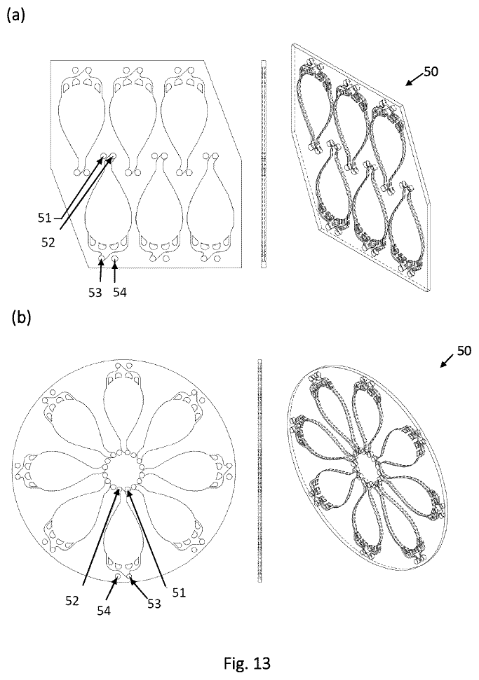

As shown in FIG. 13), the cell (50), according to this example, may comprise a plurality of streamlined cavities in planar arrangement, as shown in FIG. 13-a, or radial arrangement as shown in FIG. 13-b, to maximize power and area utilization and minimize unused area in the cell geometry. In this example, the inlets (53 and 54) are in the peripheral area of the planner arrangement, and the outlets (51 and 52) are in the central area of the planner arrangement.

### Modeling and Simulation Test

Modeling and simulation have been applied on velocity and reactant concentrations employing both rectangular and streamlined designs to a 70 cm² active area test vanadium RFB cell for the negative side reaction, to demonstrate the flow and species distribution. The modelled and simulated single-cell RFB system included. the technical features of the present invention are demonstrated in the form of velocity magnitude plots and species concentrations.

The simulated test conditions are: incompressible flow, 1.5 M Vanadium, 500 mL/min electrolyte flow at the inlet and zero relative pressure at outlet.

### Results of Modeling and Simulation Tests

Referring to FIG. (5), a comparative simulated velocity contour plots (cm s⁻¹) for a) streamlined design (I) versus b) rectangular design are shown. The resulting velocity profile shows the more uniform cross-sectional velocity through the whole surface area of the porous electrode of the streamline design (5-a), compared to the rectangular design (5-b).

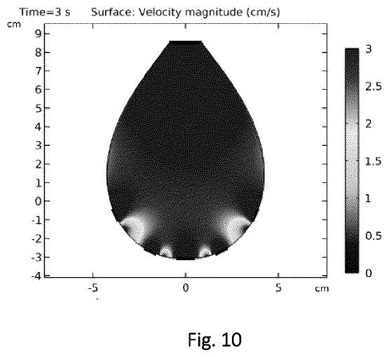

Referring to FIG. (10): simulated velocity contour plots (cm s⁻¹) for the streamlined design with manifold channels (inventive design) is shown. The resulting velocity profile (shown in FIG. 10) still show uniform cross-sectional velocity through the whole surface area of the porous electrode.

Referring to FIG. (6), comparative simulated Vanadium species (V⁺) concentration contour plots (mol m⁻³) at the electrode/collector interface is shown for a) streamlined design (I) at 1s, b) streamlined design at 3s c) rectangular design at 1s and d) rectangular design at 3s. Vanadium species concentrations and flux plots demonstrated better reactant distribution and flow pattern compared to the rectangular design.

### Pumping Power:

Power consumption by pumps is proportional to the overall pressure drop (the sum of pressure drop in stack and piping system) and can be calculated from the following equation:

$$Ph = \frac{Q P}{n}$$

where Ph is the power in (W), Q is the electrolyte flow rate in (L/min), P is the pressure drop in (kPa) and n is the pump efficiency in (%).

For instance, in this setup, assuming same pressure drop in the piping system for both shapes, streamlined and rectangular shape, the pumping powers are 50.2 (W) and 55.8 (W) for streamlined and rectangular shape, respectively. With reduced power consumption of around 11% for the streamlined shape design.

Referring to FIG. (7), comparative simulated pressure drop plots (kPa) for a) streamlined design, of example I, and b) rectangular design are shown. The overall pressure drop of rectangular design (calculated from the simulation results) is about 50 kPa, where the streamlined design has a pressure drop of about 45 kPa.

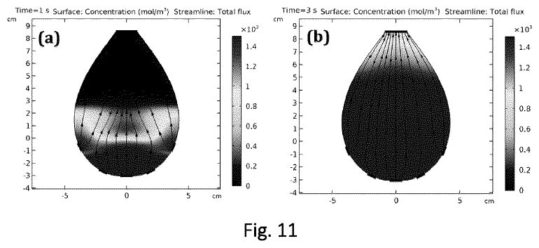

FIG. 11) shows simulated V³⁺ concentration contour plots (mol m⁻³) at the electrode/collector interface for streamlined design with manifold, example II, at 1s, b) streamlined design with manifold at 3s. Vanadium species concentrations and flux plots, shown in FIG. 11, demonstrated very good reactant distribution and flow pattern, while the overall pressure drop of this design found to be 40 kPa. However, introducing such manifold and channels to the streamlined design of the cell stack in example II will increase manufacturing costs in comparison to the that of the stack cell of example I, but the costs thereof are still less than that of manufacturing the rectangular stack. In addition, the electrolyte distribution will be enhanced in the electrode and the pressure drop will be decreased inside the stack and subsequently the pumping power consumption will be decreased and the internal losses of the battery will be minimized, resulting in ultimate overall system's efficiency.

At all events, Using the streamed design stack causes cost reduction due to removal of dead ends from conventional rectangular. This cost reduction could be reflected in the manufacture stage as 12% cost reduction. This percentage has been calculated by the inventors, assuming that same footprint 104 cm² of the two designs, the cost of manufacturing the membrane could be reduced from 146 AED for the conventional rectangular design up to 121 AED for the streamlined design. The cost of the gaskets could be reduced from 157 AED for the conventional rectangular design up to 154 AED for the streamlined design. The costs of manufacturing electrodes could be reduced from 273 AED for the conventional rectangular design up to 229 AED for the streamlined design. The costs of manufacturing flow frames could be reduced from 326 AED for the conventional rectangular design up to 289 AED for the streamlined design.

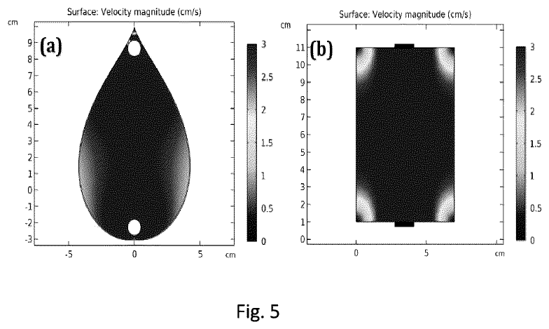

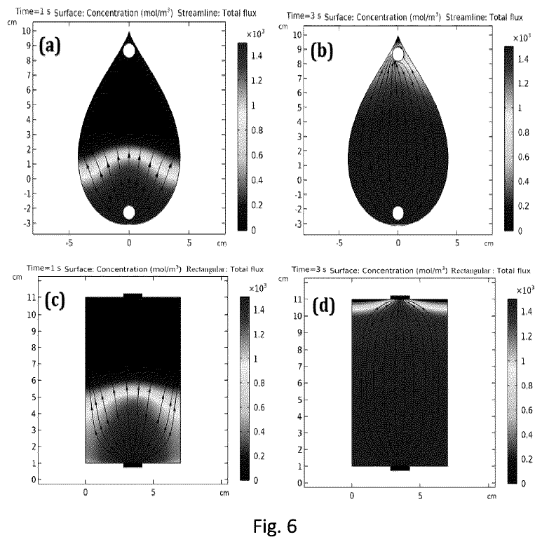

Further, as concluded from the comparative tests, there are other substantial advantages for the streamlined shape in comparison to other designs. For example, the streamlined shape of the electrode/flow frame eliminates the inactive sites of the electrode without the need of using complex manifold channels. Using such streamlined geometry facilitates normalizing the current distribution, and therefore the reaction rate in the cell. Better current distribution and reaction rates are achieved by better and more uniform cross-sectional velocity through the whole surface area of the porous electrode and superior gradient reactant species concentration at the electrode/collector interface, both factors are later explained and demonstrated in FIG. 5 and FIG. 6. Reducing the current distribution and reaction rate differences between inlet and outlet side will ensure less degradation of the electrode and subsequently reduces the maintenance cost of the whole system. Other shapes, for instance, circular shape, triangular shape, trapezoidal shape, either comprises sharp edges or the difference between the inlet to outlet dimensions causes higher pressure drop. Therefore, the streamlined shape design will have much better performance.

One more advantage, as shown from the results of the pumping power tests, the streamlined shape also facilitates less flow pumping rate (lower pumping power consumption) by introducing smooth streamlined flow in the electrode. The pumping power consumption is proportional to the pressure drop (45 kPa calculated from the simulation results) which is generated by passing the electrolyte through the stacks. The decreased pumping power consumption reduces the internal losses of the battery and the higher current densities allow better utilization of the battery system, therefore better overall system efficiency and employment can be achieved. In addition, Said streamlined shape allows the use of high current densities, while better distributed current densities over the electrode surface can be utilized by increasing the reactants velocity and concentrations. With fine tuning of the final design, the presented stack should provide smooth streamline flow through the cell electrodes.

Another advantage is that the streamlined shape will eliminate the inactive sites of the electrode, which usually exists at the four corners of the conventional rectangular stack, (demonstrated in blue color in FIG. 5b). without the need of using complex manifold channels by simply cutting off the unused part of the material and supply the electrolyte directly to the electrode by introducing an inlet inside the geometry of the electrode.

It will be appreciated by those skilled in the art that changes could be made to the embodiments described above without departing from the broad inventive concepts thereof. It is understood, therefore, that this invention is not limited to the particular embodiments disclosed, but it is intended to cover modifications within the scope of the present disclosure.

### REFERENCES

[1] Q. Zheng, F. Xing, X. Li, T. Liu, Q. Lai, G. Ning, H. Zhang, Dramatic performance gains of a novel circular vanadium flow battery, Journal of Power Sources, Volume 277, 2015, 104-109.
[2] N. Gurieff, C. Y. Cheung, V. Timchenko, C. Menictas, Performance enhancing stack geometry concepts for redox flow battery systems with flow through electrodes, Journal of Energy Storage, 22, 2019, 219-227.
[3] Yue, M., Zheng, Q., Xing, F., Zhang, H., Li, X. and Ma, X. (2018), Flow field design and optimization of high power density vanadium flow batteries: A novel trapezoid flow battery. AICHE J., 64:782-795.
[4] S. Ressel, A. Laube, S. Fischer, A. Chica, T. Flower, T. Struckmann, Performance of a vanadium redox flow battery with tubular cell design, Journal of Power Sources, Volume 355, 2017, 199-205.
[5] C. Stolze, C. Schmerbauch, C. Friebe, U. S. Schubert, A Tubular Polymer Redox Flow Battery with a Ceramic Membrane, Energy Technol., 5, 2017, 225.
[6] G. Muthuraman, L. Boyeol, M. Il-Shik, Na-β-Alumina as a Separator in the Development of All-Vanadium Non-Aqueous Tubular Redox Flow Batteries: An Electrochemical and Charging-Discharging Examination Using a Prototype Tubular Redox Flow Cell, Journal of The Electrochemical Society, Volume 165, Number 9, 2018, 1920-1924.
[7] R. Gundlapalli, S. Kumar, S. Jayanti, Stack Design Considerations for Vanadium Redox Flow Battery, INAE Lett 3, 2018, 149-157.
[8] J. Gielis, A generic geometric transformation that unifies a wide range of natural and abstract shapes. Am. J. Bot., 2003, 90:333-338.

1. A redox flow battery cell stack comprising at least one membrane; at least two flow frames disposed on both sides of the membrane; at least two electrodes disposed in cavities inside the flow frames; at least two gaskets between said frames, at least two bipolar plates and at least two outer frames; and two inlets and two outlets for circulating electrolytes; characterized in that:
said electrodes have a streamlined design; wherein the length thereof is larger than the width thereof;
and the inlet and middle portions having dimensions larger than the outlet thereof.

2. The redox flow battery cell stack according to claim 1, characterized in that the bipolar plate and flow frame are combined to form one component or divided into two separate components.

3. The redox flow battery cell stack according to claim 1, characterized in that the cell comprises electrolyte inlets at the base of the cell, and electrolyte outlets at the apex thereof.

4. The redox flow battery cell stack according to claim 3, characterized in that the cell comprises fillet or rounded end at the apex to decrease the pressure drop and increase utilization of the electrode.

5. The redox flow battery cell stack according to claim 1, characterized in that the inlets and outlets are inside the geometry of the electrode area.

6. The redox flow battery cell stack according to claim 1, characterized in that the bipolar plate comprises the streamlined design, or any other shapes.

7. The redox flow battery cell stack according to claim 1, characterized in that the inlets and outlets of the electrolyte are placed outside the electrode area, wherein the negative and positive electrodes overlapping reach 100%.

8. The redox flow battery cell stack according to claim 7, characterized in that the flow frames/bipolar plates comprise inlet channels manifold dividing the electrolyte path into at least two sub-channels.

9. The redox flow battery cell stack according to claim 1, characterized in that the cell stack comprises a plurality of streamlined cavities in planar arrangement or radial arrangement, or any other arrangements.

10. The redox flow battery cell stack according to claim 1, characterized in that the bipolar plate structure comprises veins as protrusions directed towards the electrode side.

11. The redox flow battery cell stack according to claim 1, characterized in that the streamlined design of the electrode has a symmetrical plane at the bilateral axis.

12. The redox flow battery cell stack according to claim 1, characterized in that the outer frames of the cell comprise one of the following shapes: rectangular shape, streamlined design shape, circular shape or any other shapes.
